(19) United States
(12) Patent Application Publication
(10) Pub. No.: US 2024/0012733 A1
(43) Pub. Date: Jan. 11, 2024

(54) SYSTEM AND METHOD FOR QUANTIFYING DIGITAL EXPERIENCES

(71) Applicant: Nexthink SA, Prilly (CH)

(72) Inventors: Marc Petter, Lausanne (CH); Owain Richards, Yens (CH); Vlad Lapadatescu, Bernex (CH); Tomasz Slota, Lausanne (CH); Iason Sklavenitis, Lausanne (CH); Samuele Gantner, Assens (CH)

(21) Appl. No.: 17/810,902

(22) Filed: Jul. 6, 2022

(51) Int. Cl. G06F 11/34

(52) U.S. Cl. CPC G06F 11/3419; G06F 11/3466; G06F 2201/81

(57) ABSTRACT

Systems, methods, and computer-readable storage media for determining a user's digital experience. The system receives technology performance data for one or more periods of time. The technology performance data includes: endpoint data identifying operational aspects of the at least one client device, application data identifying operational aspects of at least one business application executed by the at least one client device, and collaboration data identifying at least one collaboration program executed by the at least one client device. Using that data, the system calculates the user's digital experience which can be transmitted to others for future use.

### BACKGROUND

### 1. Technical Field

The present disclosure relates to quantifying digital experiences, and more specifically to determining on a periodic basis how users of technology are enjoying their experience, and are productive with it to deliver their job.

### 2. Introduction

Information Technology (IT) services are an important part of the modern work experience. However, quantifying and measuring the quality of user experiences with IT services and solutions remains a difficult challenge.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system from at least one client device via a network, technology performance data of the at least one client device over a plurality of periods of time, the at least one client device being associated with a user and an IT environment, the technology performance data comprising: endpoint data identifying operational aspects of the at least one client device; application data identifying operational aspects of at least one application executed by the at least one client device; and collaboration data identifying at least one of a collaboration software program executed by the at least one client device, wherein the endpoint data, the application data, and the collaboration data comprise time metadata and IT environment metadata identifying when and in which context an event took place; calculating, via at least one processor of the computer system for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time; computing, via the at least one processor, a cumulative experience score over a selected timeframe by combining experience levels associated with the selected timeframe and within the plurality of experience levels; and transmitting the plurality of experience levels and the cumulative experience score to an Information Technology team.

A system configured to perform the concepts disclosed herein can include: at least one processor; and a non-transitory computer-readable storage medium having instructions stored which, when executed by the at least one processor, cause the at least one processor to perform operations comprising: receiving, from at least one client device via a network, technology performance data of the at least one client device over a plurality of periods of time, the at least one client device being associated with a user, the technology performance data comprising: endpoint data identifying operational aspects of the at least one client device; application data identifying operational aspects of at least one application executed by the at least one client device; and collaboration data identifying at least one of a collaboration software program executed by the at least one client device, wherein the endpoint data, the application data, and the collaboration data comprise time metadata and IT environment metadata identifying when and in which context an event took place; calculating, for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time; computing a cumulative experience score over a selected timeframe by combining experience levels associated with the selected timeframe and within the plurality of experience levels; and transmitting the plurality of experience levels and the cumulative experience score to an Information Technology team.

A non-transitory computer-readable storage medium configured as disclosed herein can have instructions stored which, when executed by a computing device, cause the computing device to perform operations which include: receiving, from at least one client device via a network, technology performance data of the at least one client device over a plurality of periods of time, the at least one client device being associated with a user, the technology performance data comprising: endpoint data identifying operational aspects of the at least one client device; application data identifying operational aspects of at least one application executed by the at least one client device; and collaboration data identifying at least one of a collaboration software program executed by the at least one client device, wherein the endpoint data, the application data, and the collaboration data comprise time and IT environment metadata identifying when and in which context an event took place; calculating, for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time; computing a cumulative experience score over a selected timeframe by combining experience levels associated with the selected timeframe and within the plurality of experience levels; and transmitting the plurality of experience levels and the cumulative experience score to an Information Technology team.

### BRIEF DESCRIPTION OF THE DRAWINGS

FIG. 1 illustrates an example system configuration;

FIG. 2 illustrates an example of digital experience levels being calculated for different periods of time;

FIG. 3 illustrates an example hierarchy of how the digital employee experience is determined for a given period of time;

FIG. 4 illustrates an example of how the levels for higher levels within a hierarchy are determined based on lower level levels;

FIG. 5 illustrates an example of multiple time periods with time period experience levels and a cumulative experience score;

FIG. 6 illustrates an example method embodiment; and

FIG. 7 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Methods, systems, and computer-readable media configured as disclosed herein can quantify and measure an individual's digital experience level as they interact with IT services and solutions. While IT services and solutions (“IT systems”) are designed to make workers more productive and satisfied, determining if those services and solutions are working as desired, and the resulting impact on the worker experience, requires analyzing many different aspects of how the worker interacts with the IT systems. To determine the experience levels for specific time periods, as well as the overall cumulative experience score over a longer timeframe including these time periods, systems configured as disclosed herein can capture the experiences of workers interacting with the different IT systems over different periods of time and determine the worker's experience for each respective period of time based on the captured data. For a given time period, the system can collect multiple different types of data, and an experience level for that data type can be determined. From these multiple experience levels (each associated with a data type) for a given time period, different data determinations can be made. First, an overall experience level for that time period can be determined, where the overall experience level of that time period can be calculated based on weights associated to experience levels' severity quantifying the overall experience of the user over this time period. In addition, the experience levels over multiple time periods can be compiled together, allowing the system to calculate a rolling average for how the user's experience has been over multiple periods of time to provide the overall cumulative experience score for a longer timeframe.

Consider the following example. An employee is working on their computer, and as the employee interacts with their computer, databases, networks, etc., one or more monitoring algorithms are operating in the background. Each time the employee successfully interacts with software, a database, an application, a network, etc., an electronic notification that a successful interaction occurred can be transmitted from the employee's computer across a network to a central computing system. If the employee interacts with the software, database, application, network, etc., in a negative way (e.g., the application crashes, the database is inaccessible, the network lags, etc.), an electronic notification regarding the negative interaction can be transmitted from the employee's computer across the network to the central computing system. Likewise, if the employee interacts with technology in a manner which is neither positive nor negative, an electronic notification indicating a neutral interaction can be transmitted to the central computing system.

These positive, negative, and neutral notifications (e.g. data) can be transmitted for multiple monitored aspects on a constant basis, periodic basis, or batch basis. For example, in some cases the employee's computer, and the associated monitoring software, can transmit all notifications, or a summary of all notifications, once an hour (i.e., periodic reporting) (note that the use of an hour is exemplary—other periods of time may also be used), reducing the bandwidth necessary for the communications. In other cases, the transmission can occur once a predetermined threshold of notifications has been obtained (i.e., batch reporting), which again saves bandwidth. In other cases, the notifications can be transmitted as they occur, providing the latest details to the central computing system at all times. In yet other cases, the way in which reporting is performed can vary depending on specific IT problems encountered, based on repeating instances of negative interactions (e.g., if the employee continues to have negative experiences, the reporting may change from batch to continuous so that IT personnel can immediately be made aware of the issue).

Once the data/notifications are received by the central computer system, the system can calculate, for both a type of experience measurement being analyzed and the associated period of time in which the notification was issued, an experience level for the type of experience being measured. This can, for example, be based on a threshold number of occurrences specific to that type of interaction occurring, or based on the amount of time where the occurrences are happening. If, for example, the employee is using ZOOM or another video conferencing system, possible errors could include lag, lack of audio, lack of video, inability to connect, or application crash. While the employee's computer may track and report each interaction, the system may have a single threshold limit to define a negative experience level if the application crashes or does not connect, but may have a threshold of three lag occurrences for a neutral experience, and five lag occurrences for a negative occurrence. Likewise, if the video does not display for five seconds the experience may shift from positive to neutral, and then if the video does not display for ten seconds may shift from neutral to negative. In some cases these thresholds can be manually set by IT services, whereas in other cases these thresholds can be dynamically updated by the computer system based on historical data. The thresholds can be set for an entire organization. In other cases, the thresholds can vary based on the unique circumstances of each individual employee, such that the thresholds for employee “A” vary from those of employee “B”.

Using the data for each type of interaction and the associated thresholds, the system can identify an experience level for that interaction type which is specific to the period of time being analyzed, such that there are multiple experience levels for a given period of time, each experience level being associated with a particular type of interaction or other part of the user experience. Based on these multiple experience levels, the system can determine a time period experience level, which is a combination of one or more of the individual experience levels calculated for that period of time.

In some configurations, the time period experience level can be based on the lowest experience level the user has during that period of time. For example, if the computer system has a hierarchy for the different ways in which the user can interact with the system, the overall experience level can reflect the lowest experience level of any sub-level. The result is that if, for example, the employee's network communications experience level is positive for a given period of time, their overall experience level for that period of time may be negative if the employee had the a negative experience with a different aspect of IT. In other cases, the system can weight the different experiences based on their positions within the hierarchy, such that a particularly frustrating experience would be weighted higher, and thus it would be more likely that the overall experience level will be negative. That is, the system can weight certain types of interaction more than others, with the result being that the time period experience level reflects a weighted average of individual types of interaction. For example, the weights can be based on the impact on the user experience (e.g., the poorer an experience, the higher the weight).

In many instances, the periods of time for which experience levels are calculated are contiguous, such that one period of time immediately follows another. However, in other instances, there may be gaps between the calculated periods of time. This can be due, for example, to the employee being offline, not using IT services, etc.

A cumulative experience score for a given user across multiple time periods can be calculated on a rolling window. This cumulative experience considers all the experience levels calculated during this rolling window, and combines the experience levels together to compute a cumulative experience score (or KPI (Key Performance Indicator)) which can reflect the user's overall experience level over multiple time periods. Like the time period experience levels, the cumulative experience score can be based on different weights associated to each experience level, such that the weights vary according to the impact on the user experience (e.g., the poorer an experience, the higher the weight). For example, the cumulative experience score can look to the past seven days, with the experience level less focused on daily incidents and more focused on managing problems impacting the employee's digital experience. Once the time period experience levels and cumulative experience score is reported to IT groups, and particularly once trends are able to be calculated for a single user and/or for groups of users, the IT groups be able to quantify and measure the digital experience of employees and make changes or corrections. In some cases, these groups of users may combine data from users that use distinct operating systems on their computing devices, such as some users using MICROSOFT WINDOWS and other users using APPLE OS. In other cases, a group of users may have some users using different sets of equipment (e.g., some on tablets, others on laptops). By collecting data from users using different equipment and/or different operating systems, the systems disclosed herein overcome the technical differences associated with those equipment/software distinctions, resulting in an improved capacity to diagnose common issues across distinct technical platforms.

With that general description, consider the examples provided in the figures.

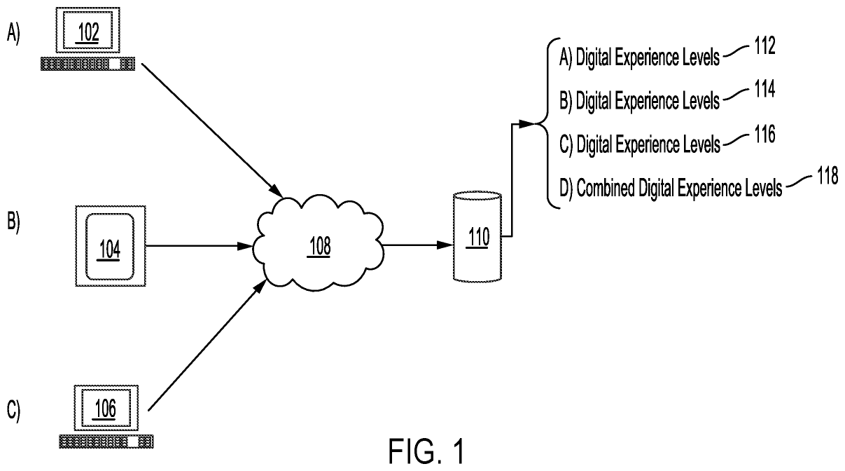

FIG. 1 illustrates an example system configuration. In this example, there are multiple computers A 102, B 104, and C 106, which employees or other users can use. These computers 102, 104, 106 can be mobile computing devices such as mobile phones, tablets, or laptops, or can be other terminal computing devices such as meeting room videoconferencing equipment. These devices 102, 104, 106 are monitoring the activities of their users, then reporting on the users' activities to a server (or other computing device) 110 across a network 108. The server 110 can process the data for each individual computer 102, 104, 106 over time, determine if the various data received for a given user meets the thresholds for positive, neutral, or negative experiences, and determine the user's overall experience level for each time period where data was received. In this manner the system generates an experience level 112 corresponding to computer A 102, another experience level 114 corresponding to computer B 104, and another experience level 116 corresponding to computer C 106. The system can also create one or more combined digital experience levels 118, which use one or more aspects of the individual experience levels 112, 114, 116, and their associated data, to create information regarding how all three computers 102, 104, 106 are being used and interacted with. For example, in some cases the combined digital experience level 118 may be an average of the individual experience levels 112, 114, 116. In other cases, the combined digital experience level 118 may represent the experiences of individuals from a common department, individuals with a common job, individuals with a common type of laptop, individuals that are individually using the same software on their respective machines, individuals trying to function in a common period of time, individuals co-located in a common geographic area, individuals trying to access a common database, etc.

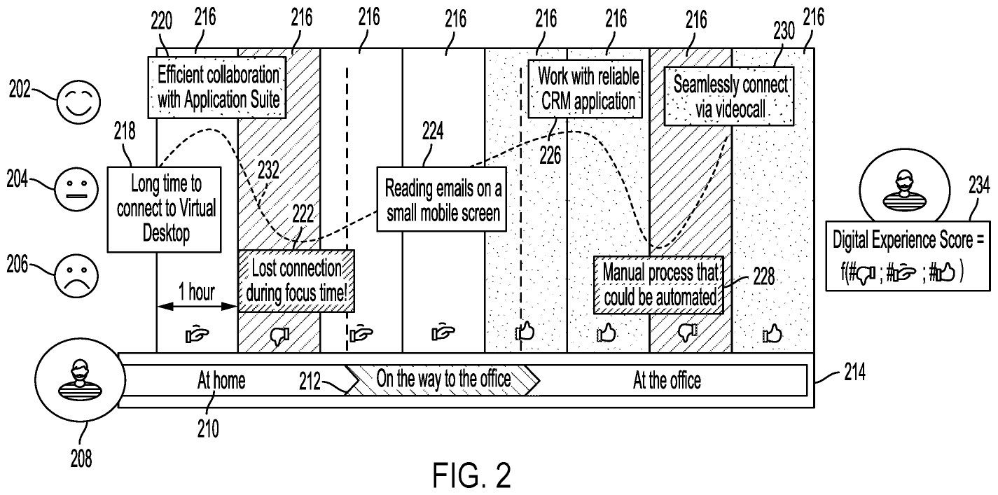

FIG. 2 illustrates an example of digital experience levels being calculated for different periods of time. The example illustrated in FIG. 2 is for a single employee/user. In cases where multiple digital experiences are being calculated for different employees/users, each individual would have their own individual period chart such as that illustrated in FIG. 2. As illustrated, FIG. 2 has an individual working over the course of a day, first at home 210, then on the way into the office 212, and then at the office 214. Time periods (illustrated as an hour) 216 are also illustrated. While the employee is working, positive 202, neural 204, and negative 206 ratings are given to various experiences of the employee. Depending on the nature of the experience, the employee's overall experience level for each time period 216 can be identified, as well as an overall experience level 232, which is a continuous estimation of the employee's digital experience.

For example, in the first hour, the user experiences a long time to connect to their Virtual Desktop 218, as well as an efficient collaboration with an application suite 220, resulting in a neural experience level. In the second hour, the user loses connection during focus time 222, resulting in a negative experience level for the period, which extends to a neutral rating in the third hour. In the fourth hour the user reads emails on a small mobile screen 224 while commuting to work 212, resulting in a neutral rating. Once the user arrives at work, they work with a reliable CRM (Customer Relationship Management) application 226, resulting in positive experiences, then perform a manual process that could be automated 228, resulting in a negative experience level. Finally, the user is able to seamlessly connect via a videocall 230, resulting in a positive experience level. In order to compute the cumulative experience score of this user over the multiple time periods illustrated in this example, the system combines the different experience levels.

IT personnel receive data regarding the time period(s), such as the user experience levels, the time period experience levels (i.e., for each hour), the cumulative experience score (or KPI) for the multiple time periods, and any associated data. The IT personnel can then look at the positive, neutral, and negative, and based on that data make modifications to the IT environment such that future experiences will be more positive for the user, as well as other users within the organization.

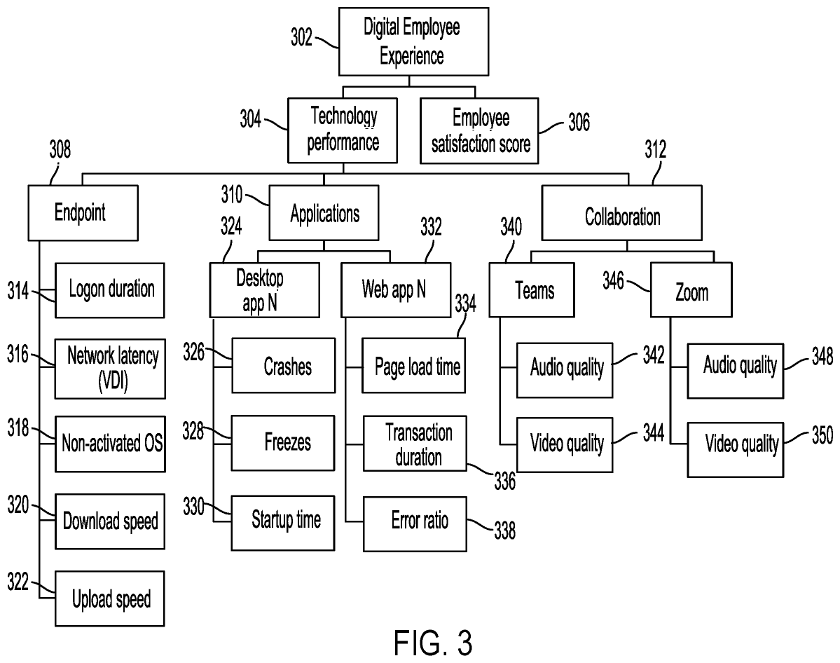

FIG. 3 illustrates an example hierarchy of how the digital employee experience is determined for a given period of time. Preferably, systems configured as disclosed herein utilize a hierarchy to organize the types of experiences the user is having with IT systems. As illustrated, the overall digital employee experience 302 can be a combination of two factors: the technology performance 304 and an employee satisfaction score 306. In other configurations, the employee satisfaction score 306, which is a subjective score produced by the employees themselves based on their feelings toward their IT experience, may not be utilized.

Within the technology performance factor 304 are three different types of sub-factors: endpoint 308 factors, which are factors associated with hardware performance; application 310 factors, which are associated with performance of computer applications; and collaboration 312 factors, which are associated with how collaboration software, such as conferencing solutions, performed. Non-limiting examples of the endpoint 308 factors can include logon duration 314, network latency for a VDI (Virtual Desktop Interface) 316, non-activated OS (Operating System) 318, download speed 320, and upload speed 322.

Non-limiting examples of application factors can include data associated with specific apps, such as a non-specific “Desktop app N” 324 or a “Web app N” 332. Within the desktop app N 324, exemplary data which can be collected can include the number of application crashes 326, the number of freezes 328, and the startup time 330 for the individual application. Non-limiting examples of web application 332 data which can be collected can include page load time 334, transition duration 336, and error ratio 338.

Collaboration 312 data refers to data obtained in applications or software where individual employees can speak with, see, and/or otherwise work with other employees, such as (but not limited to) video conferencing software. Examples can include MICROSOFT TEAMS 340 and ZOOM 346. For each of these, the system can collect data such as audio quality 342, 348 and video quality 344, 350, for the respective video conferencing software.

The hierarchy defines how experience levels are calculated and defined, with the endpoint 308 data having an experience level calculated from datapoints 314, 316, 318, 320, 322 lower in the hierarchy. Other categories of data, such as applications 310 data and collaboration data 312, are similarly determined based on the data lower in the hierarchy for those respective datatypes. If other types of data are collected (beyond endpoint 308, application 310, and collaboration 312), those other data types can be derived from sub-categories of data located within the hierarchy.

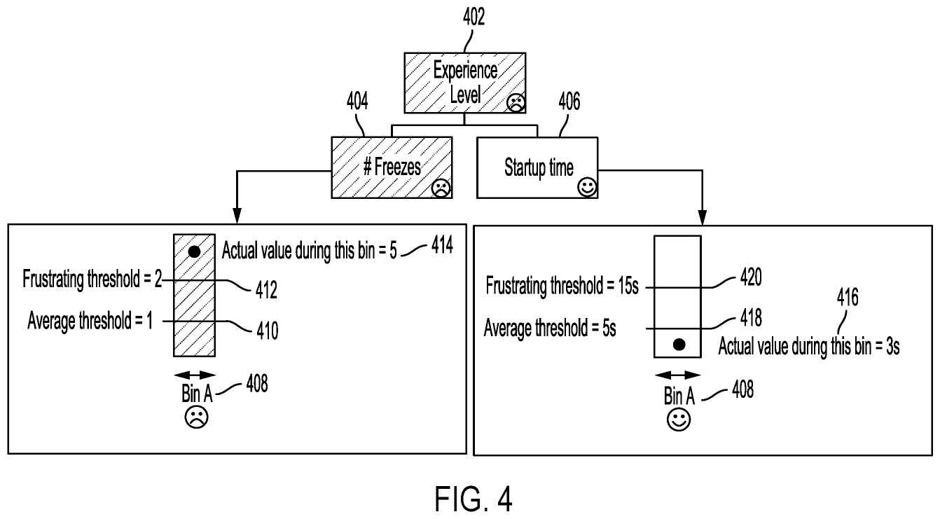

FIG. 4 illustrates an example of how the experience levels for higher levels within a hierarchy are determined based on lower level experiences. In this example, as illustrated, the experience level 402 is based on a combination of two lower categories, the number of freezes 404 and the startup time 406. The experience level for the number of freezes 404 is negative (illustrated by the shading) within the “bin” 408 (a specific period of time which is being analyzed). This is because for freezes, there are predetermined thresholds 410, 412 which are used to determine the user's experience level with respect to freezes. In this example, if the user experiences a single freeze 410 (the first threshold), the experience level drops from positive to neutral, and if the user experiences two or more freezes 412 (the second threshold), the experience level drops from neutral to negative. Because, in this example, the actual number of freezes was five 414, the experience level with respect to freezes 404 for this bin/period is negative, illustrated by the frowning face and the shading. With respect to startup time 406, thresholds have been established at five seconds 418 and fifteen seconds 420. In this case, the actual startup time was three seconds 416, with the result that the experience level for this time period 408 was positive (illustrated by the smiley face and the lack of shading).

With the experience levels for the number of freezes 404 and the startup time 406 for a common period of time determined, the system determines the overall experience level 402 for this period of time based on the lower experience level found among the subsidiaries 404, 406. In this case, the negative experience level associated with the number of freezes 404 renders the overall experience level 402 negative. In other configurations, the various subsidiaries (in this case, 404, 406) can have their experience levels weighted. For example, if there are multiple neutral subsidiaries, the overall experience level may be negative simply due to the aggregation of so many neutral subsidiaries. In other cases, an application or aspect of the IT services may be particularly important, such that how the employee interacts with that one aspect outweighs other factors in determining the overall experience level.

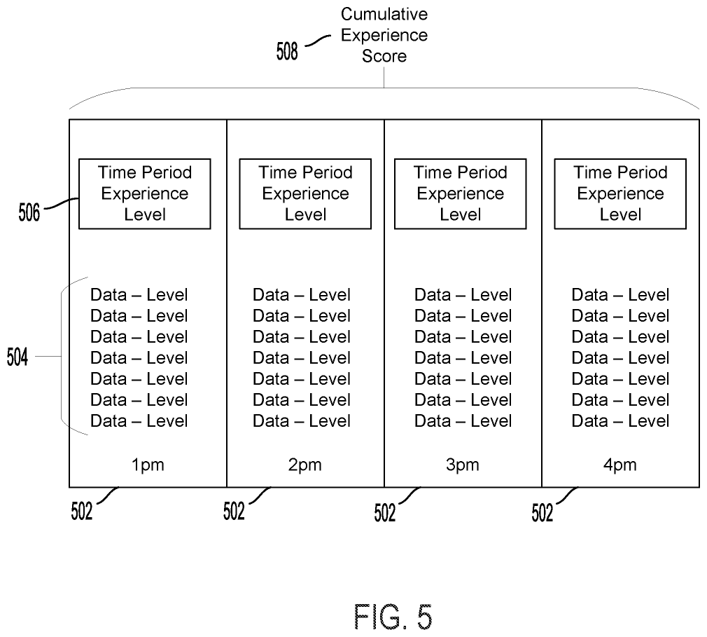

FIG. 5 illustrates an example of multiple dime periods with time period experience levels and a cumulative experience score. As illustrated, there are multiple time periods 502, where data from multiple applications or hardware sensors are being collected. For each type of data an experience level 504 of the user(s) is calculated within a given time period, as illustrated by the multiple types of data and corresponding experience levels 504. Based on the collection of data and experience levels 504 within any given time period 502, a time period experience level 506 can be calculated. In some cases this time period experience level 506 is determined using one or more of an average, a weighted average, and/or the lowest experience level identified in the time period. Once the time period experience levels 506 for multiple time periods 502 have been calculated, the system can calculate a cumulative experience score 508 representing multiple time periods 502. In some cases, such as the illustrated example, the time periods 502 can be contiguous, whereas in other cases there can be chronological gaps between the time periods 502 used for a cumulative experience score 508.

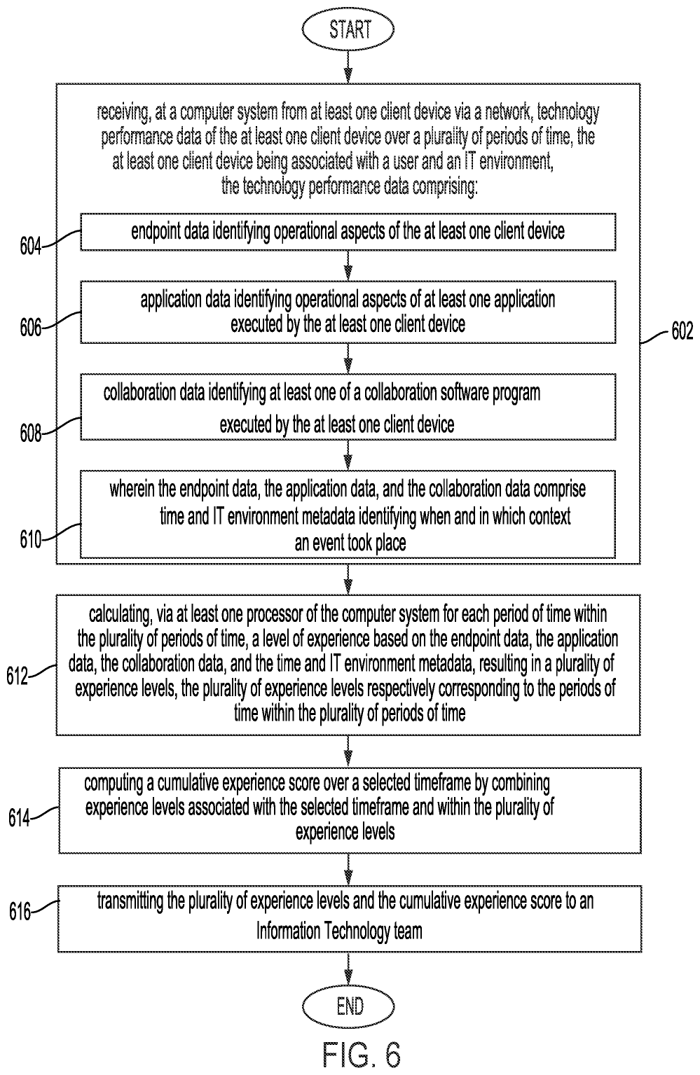

FIG. 6 illustrates an example method embodiment. As illustrated, the method can include receiving, at a computer system from at least one client device via a network, technology performance data of the at least one client device over a plurality of periods of time, the at least one client device being associated with a user (602), the technology performance data comprising: endpoint data identifying operational aspects of the at least one client device (604); application data identifying operational aspects of at least one business application executed by the at least one client device (606); and collaboration data identifying at least one collaboration software program executed by the at least one client device, (608), wherein the endpoint data, the application data, and the collaboration data comprise time metadata and IT environment metadata identifying when and in which context an event took place (610).

The method continues, with the system calculating, via at least one processor of the computer system for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time (612). The system can then compute a cumulative experience score over a selected timeframe by combining experience levels associated with the selected timeframe and within the plurality of experience levels (614). The plurality of experience levels and cumulative experience score are transmitted to an Information Technology team (616).

In some configurations, the plurality of periods of time can include at least one of consecutive minutes, consecutive hours, and consecutive days.

In some configurations, the plurality of periods of time can include non-consecutive periods of time.

In some configurations, the collaboration software program can include at least one of MICROSOFT TEAMS AND ZOOM.

In some configurations, the plurality of experience levels and the cumulative experience score can be computed for a single individual user, whereas in other configurations the plurality of experience levels and the cumulative experience score are computed for a plurality of users. Where the plurality of experience levels and the cumulative experience score are computed for a plurality of users, the plurality of users may use distinct computer operating systems. For example, some users may us MICROSOFT WINDOWS, whereas other users may use APPLE OS.

In some configurations, the calculating of the level of experience can further include: comparing each metric within the endpoint data, the application data, and the collaboration data to at least one respective predetermined metric-specific threshold, resulting in metric comparisons; identifying, based on the metric comparisons, metric-specific experience levels; and assigning the level of experience for each period of time based on a lowest ranked level of experience within the metric-specific experience levels. In such configurations, the at least one respective predetermined metric-specific threshold can be customized to a user.

In some configurations, the plurality of experience levels can be selected from categories comprising positive, negative, and neutral.

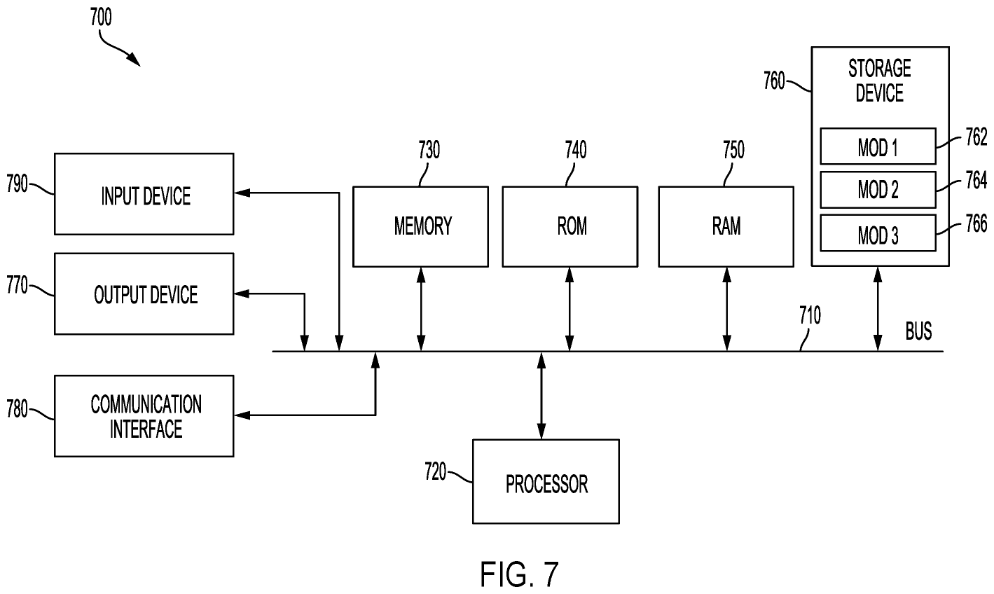

With reference to FIG. 7, an exemplary system includes a general-purpose computing device 700, including a processing unit (CPU or processor) 720 and a system bus 710 that couples various system components including the system memory 730 such as read-only memory (ROM) 740 and random-access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general-purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

We claim:

1. A method comprising:
receiving, at a computer system from at least one client device via a network, technology performance data of the at least one client device over a plurality of periods of time, the at least one client device being associated with a user and an IT environment, the technology performance data comprising:
endpoint data identifying operational aspects of the at least one client device;
application data identifying operational aspects of at least one application executed by the at least one client device; and
collaboration data identifying at least one of a collaboration software program executed by the at least one client device,
wherein the endpoint data, the application data, and the collaboration data comprise time metadata and IT environment metadata identifying when and in which context an event took place;
calculating, via at least one processor of the computer system for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time;
computing, via the at least one processor, a cumulative experience score over a selected timeframe by combining experience levels associated with the selected timeframe and within the plurality of experience levels; and
transmitting the plurality of experience levels and the cumulative experience score to an Information Technology team.

2. The method of claim 1, wherein the plurality of periods of time comprise at least one of consecutive minutes, consecutive hours, and consecutive days.

3. The method of claim 1, wherein the plurality of periods of time comprise non-consecutive periods of time.

4. The method of claim 1, wherein the plurality of experience levels and the cumulative experience score are computed for a single individual user.

5. The method of claim 1, wherein the plurality of experience levels and the cumulative experience score are computed for a plurality of users.

6. The method of claim 5, wherein the plurality of users use distinct computer operating systems.

7. The method of claim 1, wherein the calculating of the level of experience further comprises:
comparing each metric within the endpoint data, the application data, and the collaboration data to at least one respective predetermined metric-specific threshold, resulting in metric comparisons;
identifying, based on the metric comparisons, metric-specific experience levels; and
assigning the level of experience for each period of time based on a lowest ranked level of experience within the metric-specific experience levels.

8. The method of claim 5, wherein the at least one respective predetermined metric-specific threshold is customized to a user.

9. The method of claim 5, wherein the at least one respective predetermined metric-specific threshold is dynamically adjusted for a group of users based on historical data.

10. The method of claim 1, wherein the plurality of experience levels are selected from categories comprising positive, negative, and neutral.

11. A system comprising:
at least one processor; and
a non-transitory computer-readable storage medium having instructions stored which, when executed by the at least one processor, cause the at least one processor to perform operations comprising:
receiving, from at least one client device via a network, technology performance data of the at least one client device over a plurality of periods of time, the at least one client device being associated with a user, the technology performance data comprising:
endpoint data identifying operational aspects of the at least one client device;
application data identifying operational aspects of at least one application executed by the at least one client device; and
collaboration data identifying at least one of a collaboration software program executed by the at least one client device,
wherein the endpoint data, the application data, and the collaboration data comprise time metadata and IT environment metadata identifying when and in which context an event took place;
calculating, for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time;
computing a cumulative experience score over a selected timeframe by combining experience levels associated with the selected timeframe and within the plurality of experience levels; and
transmitting the plurality of experience levels and the cumulative experience score to an Information Technology team.

12. The system of claim 11, wherein the plurality of periods of time comprise at least one of consecutive minutes, consecutive hours, and consecutive days.

13. The system of claim 11, wherein the plurality of periods of time comprise non-consecutive periods of time.

14. The system of claim 11, wherein the plurality of experience levels and the cumulative experience score are computed for a plurality of users.

15. The system of claim 14, wherein the plurality of users use distinct computer operating systems.

16. The system of claim 11, wherein the calculating of the level of experience further comprises:
comparing each metric within the endpoint data, the application data, and the collaboration data to at least one respective predetermined metric-specific threshold, resulting in metric comparisons;
identifying, based on the metric comparisons, metric-specific experience levels; and
assigning the level of experience for each period of time based on a lowest ranked level of experience within the metric-specific experience levels.

17. The system of claim 16, wherein the at least one respective predetermined metric-specific threshold is customized to a user.

18. The system of claim 16, wherein the at least one respective predetermined metric-specific threshold is dynamically adjusted for a group of users based on historical data.

19. The system of claim 11, wherein the plurality of experience levels are selected from categories comprising positive, negative, and neutral.

20. A non-transitory computer-readable storage medium having instructions stored which, when executed by at least one processor, cause the at least one processor to perform operations comprising:
receiving, from at least one client device via a network, technology performance data of the at least one client device over a plurality of periods of time, the at least one client device being associated with a user, the technology performance data comprising:
endpoint data identifying operational aspects of the at least one client device;
application data identifying operational aspects of at least one application executed by the at least one client device; and
collaboration data identifying at least one of a collaboration software program executed by the at least one client device,
wherein the endpoint data, the application data, and the collaboration data comprise time and IT environment metadata identifying when and in which context an event took place;
calculating, for each period of time within the plurality of periods of time, a level of experience based on the endpoint data, the application data, the collaboration data, and the time and IT environment metadata, resulting in a plurality of experience levels, the plurality of experience levels respectively corresponding to the periods of time within the plurality of periods of time;
computing a cumulative experience score over a selected timeframe by combining experience levels associated with the selected timeframe and within the plurality of experience levels; and
transmitting the plurality of experience levels and the cumulative experience score to an Information Technology team.
